(19) United States
(12) Patent Application Publication
(10) Pub. No.: US 2011/0151412 A1
(43) Pub. Date: Jun. 23, 2011

(54) METHOD AND APPARATUS FOR EVALUATING A DRIVING SAFETY

(75) Inventors: Daesub YOON, Daejeon (KR); Hyun Suk Kim, Daejeon (KR); Yoon Sook Hwang, Daejeon (KR); Jong-woo Choi, Daejeon (KR); Kyong Ho Kim, Daejeon (KR); Sung Woong Shin, Daejeon (KR); Jong-Hyun Park, Daejeon (KR)

(73) Assignee: Electronics and Telecommunications Research Institue, Daejeon (KR)

(21) Appl. No.: 12/884,898

(22) Filed: Sep. 17, 2010

(30) Foreign Application Priority Data
Dec. 17, 2009 (KR) 10-2009-0126263

(51) Int. Cl. G09B 19/16

(52) U.S. Cl. 434/29

(57) ABSTRACT

An apparatus for evaluating driving safety comprises: a task/action storing unit that stores a task list and an action list, wherein the task list comprises at least one task that a driver can perform while driving and the action list comprises at least one action for performing the at least one task, a task/action defining unit that extracts a performing task that the driver currently intends from the task list and defines detailed actions for performing the performing task from the action list, a driving conduct analyzing unit that analyzes driving conduct on the basis of the performing task and the detailed actions and a driving safety evaluating unit that evaluates the degree of safe driving of the driver by using a result analyzed by the driving conduct analyzing unit.

### CROSS-REFERENCE TO RELATED APPLICATION

This application claims priority to and the benefit of Korean Patent Application No. 10-2009-0126263 filed in the Korean Intellectual Property Office on Dec. 17, 2009, the entire contents of which are incorporated herein by reference.

### BACKGROUND OF THE INVENTION

(a) Field of the Invention

The present invention relates to a method and apparatus for evaluating a driving safety.

(b) Description of the Related Art

There is a method of evaluating a driving safety based on velocity of vehicles. For example, it is determined that people are speeding when a current speed of a vehicle exceeds a speed limit, as a result of comparing the current speed of the vehicle with the speed limit. Frequency and duration of speeding can be used as basis in evaluating a driving safety. The speed limit is not determined in consideration of detailed conditions of roads, but generally depends on the laws. Therefore, evaluating a driving safety based on the vehicle speed may cause inaccurate result.

Further, there is another method of evaluating a driving safety based on whether people doze, drink, and use a mobile phone, etc. For example, driving is determined as being dangerous when a driver dozes at a wheel, and driving is determined as being safe when a driver does not doze at a wheel. With this method, an inaccurate result may be obtained because a driving safety is determined based on an extremely simple standard.

The above information disclosed in this Background section is only for enhancement of understanding of the background of the invention and therefore it may contain information that does not form the prior art that is already known in this country to a person of ordinary skill in the art.

### SUMMARY OF THE INVENTION

The present invention has been made in an effort to provide a method and apparatus for evaluating a driving safety by analyzing a driving conduct.

An embodiment of the present invention provides an apparatus for evaluating driving safety, that comprises: a task/action storing unit that stores a task list and an action list, wherein the task list comprises at least one task that a driver can perform while driving and the action list comprises at least one action for performing the at least one task, a task/action defining unit that extracts a performing task that the driver currently intends from the task list and defines detailed actions for performing the performing task from the action list, a driving conduct analyzing unit that analyzes driving conduct on the basis of the performing task and the detailed actions and a driving safety evaluating unit that evaluates the degree of safe driving of the driver by using a result analyzed by the driving conduct analyzing unit.

Another embodiment of the present invention provides a method of evaluating a driving safety, that comprises: defining a performing task that a driver currently intends and detailed actions for the performing task, analyzing driving conduct on the basis of the performing task and the detailed actions and determining the degree of safe driving by using the analyzed result.

It is thereby possible to objectively and efficiently evaluate a driving safety. Further, it is thereby possible to maximize driving safety by applying an embodiment of the present invention to an intellectually safe vehicle.

### BRIEF DESCRIPTION OF THE DRAWINGS

FIG. 1 is a diagram illustrating an apparatus for evaluating a driving safety according to an exemplary embodiment of the present invention;

FIG. 2 is a diagram illustrating a method of evaluating a driving safety according to an exemplary embodiment of the present invention;

FIG. 3 is a diagram showing an output of a task/action defining unit 120 according to an exemplary embodiment of the present invention;

FIG. 4 is a flowchart illustrating a method of analyzing a driving conduct in a driving conduct analyzing unit 130 according to an exemplary embodiment of the present invention; and

FIG. 5 is a diagram showing an output of a driving safety evaluating unit 140 according to an exemplary embodiment of the present invention.

### DETAILED DESCRIPTION OF THE EMBODIMENTS

In the following detailed description, only certain exemplary embodiments of the present invention have been shown and described, simply by way of illustration. As those skilled in the art would realize, the described embodiments may be modified in various different ways, all without departing from the spirit or scope of the present invention. Accordingly, the drawings and description are to be regarded as illustrative in nature and not restrictive. Like reference numerals designate like elements throughout the specification.

In the specification, unless explicitly described to the contrary, the word “comprise” and variations such as “comprises” or “comprising” will be understood to imply the inclusion of stated elements but not the exclusion of any other elements.

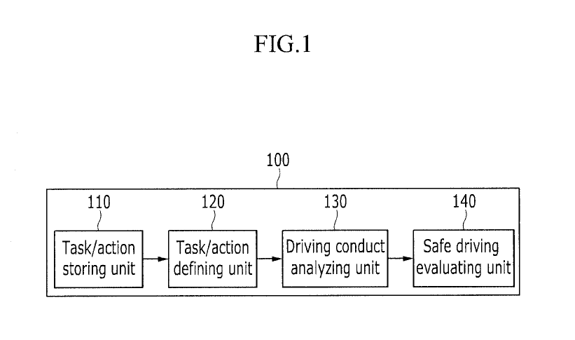

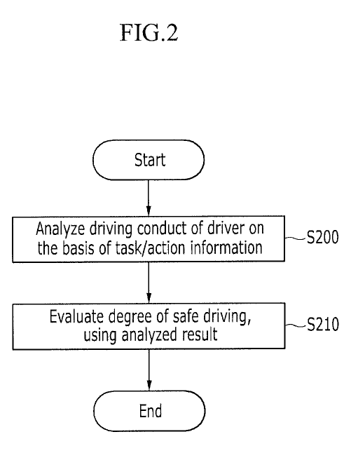

FIG. 1 is a diagram illustrating an apparatus for evaluating a driving safety according to an exemplary embodiment of the present invention, and FIG. 2 is a diagram illustrating a method of evaluating a driving safety according to an exemplary embodiment of the present invention.

Referring to FIG. 1, an apparatus for evaluating a driving safety 100 includes a task/action storing unit 110, a task/action defining unit 120, a driving conduct analyzing unit 130, and a driving safety evaluating unit 140.

Referring to FIGS. 1 and 2, the driving conduct analyzing unit 130 analyzes a driver's driving conduct based on information received from the task/action defining unit 120 (S200). For example, the driving conduct analyzing unit 130 can measure a time taken for the driver to perform actions defined by the task/action defining unit 120.

The task/action defining unit 120 defines a task that the driver currently intends, and detailed actions for performing the defined task. The detailed actions for the defined task can be basically set in advance, and may be added or deleted by operation of the driver. The task/action defining unit 120 defines the detailed actions by extracting information stored in the task/action storing unit 110. The task/action storing unit 110 stores a task list and an action list. The task list includes at least one task that the drivers can perform while driving and the action list includes at least one action for performing the at least one task. The action list may further include information on an average time for each action. The task/action storing unit 110 may be divided into a task storing unit and an action storing unit, or may be operated in one united unit.

The driving safety evaluating unit 140 evaluates a degree of safe driving of the driver on the basis of a result analyzed by the driving conduct analyzing unit 130 (S210). For example, the driving safety evaluating unit 140 can evaluate a driving safety of the driver by comparing a time substantially taken for the driver to perform the defined task with an estimated time that is calculated on the basis of the average time for each action stored in the task/action storing unit 110.

Table 1 shows a task library according to an exemplary embodiment of the present invention.

TABLE 1
Task library

Change to the right lane
Change to the left lane
Turning right at an intersection
Turning left at an intersection
U-turn
Backward parking

Referring to Table 1, the task library is expressed by a task list including tasks that a driver performs while driving. For example, the tasks that the driver performs while driving may include changing to the right lane, changing to the left lane, turning right at an intersection, turning left at an intersection, U-turning, backward parking, etc. The task list may be stored in the task/action storing unit 110. The task library may depend on a type of vehicle, a model of vehicle, and a driver's inclination. Further, the task library can be updated periodically or non-periodically.

Table 2 shows an action library according to an exemplary embodiment of the present invention.

TABLE 2

| | Average required time |
|---|---|
| Action library | (sec) |
| Looking at the right side | 0.9 |
| mirror | |
| Looking at the room mirror | 0.9 |
| Turning on the light turn | 0.8 |
| signal | |
| Turning the wheel to the right | 1 |
| Checking the distance from | 1.2 |
| the vehicle ahead | |
| Turning the wheel to the left | 1 |
| Turning off the turn signal | 0.8 |
| Shifting the gear | 1 |
| Starting the engine | 1.2 |
| Stopping the engine | 1 |
| Turning on the radio | 1.5 |
| Looking at the signal light | 1.3 |

Referring to Table 2, the action library is expressed by an action list including actions that a driver may make to perform tasks. That is, the action library may include repeated actions that the driver momentarily makes to control a vehicle while driving. For example, the actions include looking at the right side mirror, looking at the room mirror, turning on the right turn signal, turning the wheel to the right, checking the distance from the vehicle ahead, turning the wheel to the left, turning off the turn signal, shifting the gear, starting the engine, stopping the engine, turning on the radio, looking at the signal light, etc.

The action library may further include information on an average time that is taken to perform each action. The average time, for example, can be acquired from a test made for a plurality of drivers. The test can be made for general drivers or drivers classified in accordance with characteristics. That is, it is possible to classify and test drivers in accordance with the drivers' sex, age, inclination, and driving skill, and to acquire the average time.

The action library can give a weight to each action included in the action list. That is, it is possible to give relatively high weights to relatively dangerous actions and relatively low weights to relatively safe actions.

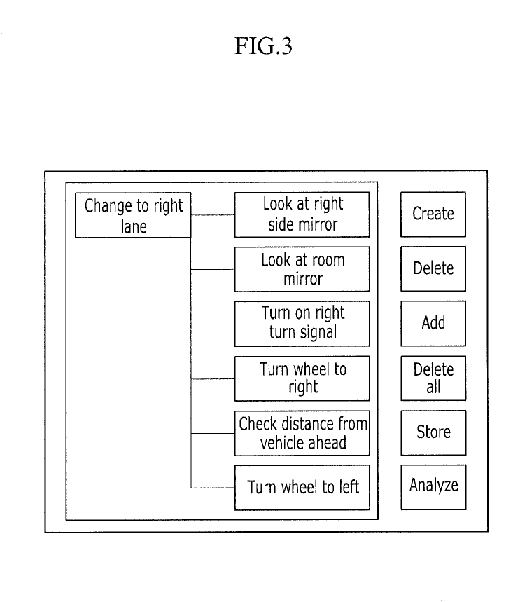

FIG. 3 is a diagram showing an output of a task/action defining unit 120 according to an exemplary embodiment of the present invention.

Referring to FIG. 3, the task/action defining unit 120 defines tasks that a driver intends and detailed actions to perform the tasks. For example, detailed actions, when a task is “changing to the right lane”, may include “looking at the right side mirror”, “looking at the room mirror”, “turning on the right turn signal”, “turning the wheel to the right”, “checking the distance from the vehicle ahead” and “turning the wheel to the left”, etc. The detailed actions for performing the tasks in the task/action defining unit may be set in advance. A process of performing the tasks may depend on a driver's inclination; therefore, setting may be changed in accordance with drivers or operators. That is, the drivers or the operators can delete some of the actions shown on the output or add actions not shown on the output.

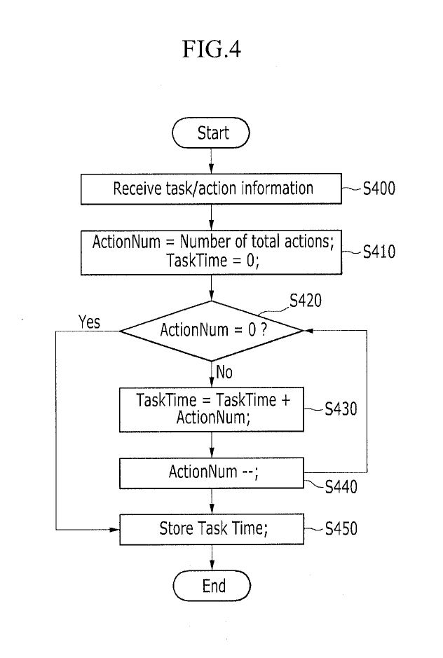

FIG. 4 is a flowchart illustrating a method of analyzing driving conduct in a driving conduct analyzing unit 130 according to an exemplary embodiment of the present invention.

Referring to FIG. 4, the driving conduct analyzing unit 130 receives information on tasks that a driver currently intends, and detailed actions that are made to perform the tasks (S400). For example, when a driver or an operator pushes an “analyzing” button in an output of a task/action defining unit 120, information on tasks and detailed actions may be inputted to the driving conduct analyzing unit 130.

The driving conduct analyzing unit 130 makes an initial setting on the basis of the information received in step S400 (S410). The number of actions “ActionNum” may be set to the number of entire detailed actions that are made to perform the tasks and a task time “Task Time” may be set to 0 in the initial setting.

The driving conduct analyzing unit 130 checks the number of detailed actions “ActionNum” whenever each detailed actions for performing the tasks are performed (S420). When the number of detailed actions “ActionNum” is not 0, a time taken to perform the previous detailed action is added to the task time “Task Time” (S430), and 1 is subtracted from the number of detailed actions “ActionNum” (S440). The taken time is added and the number of detailed actions is reduced whenever each detailed action is performed. The driving action analyzing unit 130 repeats step S420 to S440 until the number of detailed actions “ActionNum” becomes 0 (S440), and stores a total task time “Task Time”, when the number of detailed actions “ActionNum” becomes 0 (S450).

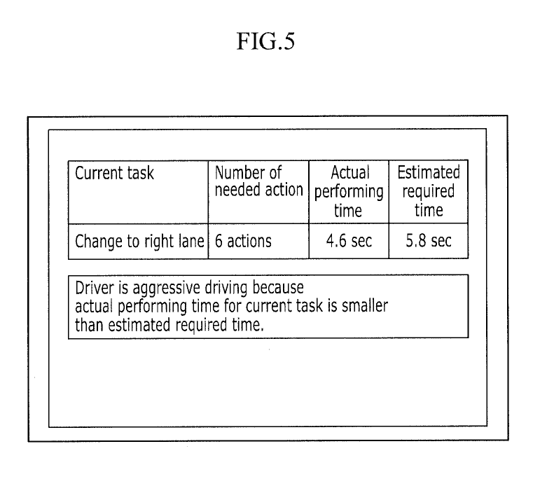

FIG. 5 is a diagram showing an output of a driving safety evaluating unit 140 according to an exemplary embodiment of the present invention.

Referring to FIG. 5, the driving safety evaluating unit 140 compares an actual time taken for a driver to perform a task with an estimated time for the task. For example, the driving safety evaluating unit 140 can receive information on the actual time from a driving conduct analyzing unit 130 and information for calculating the estimated time from a task/action storing unit 110. The following Table 3 compares the actual time with the estimated time.

TABLE 3

| | Actual performing | Estimated required |
|---|---|---|
| Action | time | time |
| Looking at the right | 0.7 sec | 0.9 sec |
| side mirror | | |
| Looking at the room | 0.7 sec | 0.9 sec |
| mirror | | |
| Turning on the right | 0.6 sec | 0.8 sec |
| turn signal | | |
| Turning the wheel to | 0.8 sec | 1 sec |
| the right | | |
| Checking the distance | 1 sec | 1.2 sec |
| from the vehicle | | |
| ahead | | |
| Turning the wheel to | 0.8 sec | 1 sec |
| the left | | |
| Total | 4.6 sec | 5.8 sec |

Referring to Table 3, the actual time taken to perform the tasks is 4.6 sec and the estimated time is 5.8 sec. Therefore, the driving safety evaluating unit 140 can evaluate that the driver is driving aggressively. Meanwhile, when weights according to characteristics of actions is provided for each action made to perform the tasks, the driving safety evaluating unit 140 considers the weight. Therefore, it is possible to give a large weight to the driving safety evaluation when a driver quickly makes dangerous actions, and a small weight to the driving safety evaluation when a driver quickly makes non-dangerous actions.

The above-mentioned exemplary embodiments of the present invention are not embodied only by an apparatus and method. Alternatively, the above-mentioned exemplary embodiments may be embodied by a program performing functions that correspond to the configuration of the exemplary embodiments of the present invention, or a recording medium on which the program is recorded.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

What is claimed is:

1. An apparatus for evaluating a driving safety, comprising:
a task/action storing unit that stores a task list and an action list, wherein the task list comprises at least one task that a driver can perform while driving and the action list comprises at least one action for performing the at least one task;
a task/action defining unit that extracts a performing task that the driver currently intends from the task list and defines detailed actions for performing the performing task from the action list;
a driving conduct analyzing unit that analyzes driving conduct on the basis of the performing task and the detailed actions; and
a driving safety evaluating unit that evaluates the degree of safe driving of the driver by using a result analyzed by the driving conduct analyzing unit.

2. The apparatus of claim 1, wherein the action list further comprises information on an average time taken to perform each action.

3. The apparatus of claim 2, wherein the driving conduct analyzing unit analyzes the driving conduct by measuring the time taken for the driver to perform the performing task.

4. The apparatus of claim 3, wherein the driving safety evaluating unit evaluates the degree of the safe driving by comparing the average time for the detailed actions with the time taken for the driver to perform the performing tasks.

5. The apparatus of claim 3, wherein the driving safety evaluating unit calculates an estimated time taken to perform the performing task by using information on the average time, and evaluates the degree of safe driving by comparing the estimated time with the time taken for the driver to perform the performing task.

6. The apparatus of claim 5, wherein
the action list further comprises information on a weight value for each action, and
the driving safety evaluating unit evaluates the degree of safe driving in consideration of the weight value for each action.

7. A method of evaluating a driving safety, comprising:
defining a performing task that a driver currently intends and detailed actions for the performing task;
analyzing driving conduct on the basis of the performing task and the detailed actions; and
determining the degree of safe driving by using the analyzed result.

8. The method of claim 7, wherein the analyzing of the driving conduct comprises measuring a time taken for the driver to perform the performing task.

9. The method of claim 8, wherein the determining of the degree of safe driving includes comparing an average time for the detailed actions with the time taken for the driver to perform the performing task.

10. The method of claim 8, wherein the determining of the degree of safe driving includes calculating an estimated time taken to perform the performing task by use of the average time for the detailed actions, and determining the degree of safe driving by comparing the estimated time with the time taken for the driver to perform the performing task.
